(19) United States
(12) Patent Application Publication
(10) Pub. No.: US 2020/0268013 A1
(43) Pub. Date: Aug. 27, 2020

(54) CACAO RAW MATERIAL-CONTAINING FROZEN DESSERT

(71) Applicant: MEIJI CO., LTD., Tokyo (JP)

(72) Inventors: Takamitsu KIKUCHI, Tokyo (JP); Terutaro SHIMAMURA, Tokyo (JP); Mariko MIKAMI, Tokyo (JP)

(73) Assignee: MEIJI CO., LTD., Tokyo (JP)

(21) Appl. No.: 16/803,417

(22) Filed: Feb. 27, 2020

(30) Foreign Application Priority Data
Feb. 27, 2019 (JP) 2019-033582

(51) Int. Cl. A23G 9/32

(52) U.S. Cl. CPC A23G 9/327; A23V 2002/00

(57) ABSTRACT

A cacao raw material-containing frozen dessert has a moisture content of 50 mass % or more, and contains 8 mass % or more of a cocoa butter component or 15 mass % or more of cocoa liquor and 0.1 to 4.5 mass % of a water-soluble dietary fiber and/or a dextrin having a weight average molecular weight of 450 or more.

### BACKGROUND

### Technical Field

The present invention relates to a cacao raw material-containing frozen dessert having a high content of a cacao-derived fat.

### Related Art

Conventionally, a large number of frozen desserts with a chocolate flavor (sometimes referred to as “cacao flavor” or “cocoa flavor”) have been on the market. Then, in the case where the appellation “chocolate” is labeled on a frozen dessert, in “The Fair Competition Code Concerning Labeling for Ice Creams and Ice Dessert”, it is specified that 0.6% or more (1.5% or more in the case of an ice cream) by weight of a cacao component is to be contained. Usually, as a cacao raw material for providing a chocolate flavor, cocoa powder is mainly used. In addition, cocoa butter, chocolate base, cocoa liquor, and the like are also used.

For example, JP H4-316453(JP 1992-316453) A discloses a frozen dessert (ice cream, etc.) that provides a sharp melting texture in the mouth, characterized in that an amount of cocoa butter sufficient to impart an authentic cocoa flavor is used as a vegetable oil/fat. It is also disclosed that the amount of cocoa butter used is most suitably 3 to 20 wt %.

### SUMMARY

However, when cocoa butter, cocoa liquor, chocolate base, or the like is abundantly used in the production of frozen desserts, because the melting point of cacao oil/fat is higher as compared with other vegetable oils/fats (palm oil, coconut oil, etc.), the frozen dessert mix thickens over time through the production steps (particularly in the aging step), significantly interfering with production. In particular, when the content of a cacao-derived fat component (cocoa butter component) is high, the thickening of the frozen dessert mix is conspicuous. Accordingly, the fluidity is lost, resulting in the deterioration of production suitability. Further, the resulting frozen dessert has a rough texture with poor soft scoop property, and the smoothness in the mouth is deteriorated.

Therefore, in a conventional frozen dessert with a chocolate flavor, usually, the content of cocoa liquor, chocolate base, or the like at most about 6 mass %, and such a dessert is flavored mainly using cocoa powder having a low content of a cocoa butter component. However, flavoring mainly using cocoa powder leads to a low cocoa butter component content, and the resulting frozen dessert has a plain taste with a weak chocolate flavor. Accordingly, a frozen dessert having a rich flavor with a strong chocolate flavor, having abundantly blended therein a cacao raw material that abundantly contains a cocoa butter component, such as cocoa liquor, cocoa butter, or chocolate base, has been demanded.

Thus, an object of the present invention is to provide a cacao raw material-containing frozen dessert having a high content of a cacao-derived fat component (cocoa butter component), which also has a low viscosity in the form of a frozen dessert mix and allows for smooth soft scoop property in the form of a frozen dessert.

The present inventors have conducted extensive research to solve the problems described above, and found that when a frozen dessert has a moisture content of 50 mass % or more, and contains 8 mass % or more of a cocoa butter component or 15 mass % or more of cocoa liquor and 0.1 to 4.5 mass % of a water-soluble dietary fiber and/or a dextrin having a weight average molecular weight of 450 or more, a cacao raw material-containing frozen dessert which has a low viscosity in the form of a frozen dessert mix and allows for smooth soft scoop property in the form of a frozen dessert can be obtained. The present invention has thus been accomplished.

That is, the present invention is the following (1) to (4).

(1) A frozen dessert having a moisture content of 50 mass % or more, including 8 mass % or more of a cocoa butter component, and 0.1 to 4.5 mass % of a water-soluble dietary fiber and/or a dextrin having a weight average molecular weight of 450 or more.

(2) A frozen dessert having a moisture content of 50 mass % or more, including 15 mass % or more of cocoa liquor, and 0.1 to 4.5 mass % of a water-soluble dietary fiber and/or a dextrin having a weight average molecular weight of 450 or more.

(3) The frozen dessert according to (1) or (2), which includes 15 mass % or more of a cacao component.

(4) The frozen dessert according to any one of (1) to (3), wherein the frozen dessert mix viscosity at 5° C. after 16 hours of aging is less than 2,000 mPa·s, and the frozen dessert hardness at −18° C. is 9 kgf or less.

The present invention enables the provision of a cacao raw material-containing frozen dessert having a high content of a cacao-derived fat component (cocoa butter component), and yet having a low viscosity in the form of a frozen dessert mix and allowing for smooth soft scoop property in the form of a frozen dessert.

### BRIEF DESCRIPTION OF DRAWINGS

FIG. 1 is a photograph showing the front view of the plunger of a rheometer used for frozen dessert hardness measurement in the Examples (drawing-substituting photograph);

FIG. 2 is a photograph showing the side view of the plunger of a rheometer used for frozen dessert hardness measurement in the Examples (drawing-substituting photograph); and

FIG. 3 is a photograph of a rheometer used for frozen dessert hardness measurement in the Examples, showing sticking by the plunger at the time of measurement (drawing-substituting photograph).

### DETAILED DESCRIPTION

The present invention will be described.

The present invention is a frozen dessert having a moisture content of 50 mass % or more, and containing 8 mass % or more of a cocoa butter component or 15 mass % or more of cocoa liquor and 0.1 to 4.5 mass % of a water-soluble dietary fiber and/or a dextrin having a weight average molecular weight of 450 or more.

Here, “cocoa butter component” in the present invention means a cacao-derived fat component (cacao oil/fat component). The content of the cocoa butter component can be adjusted by using cocoa liquor, cocoa butter (fat component raw material separated from cocoa liquor), chocolate base or quasi-chocolate base containing the same, or the like as a frozen dessert raw material. In addition, “cacao component” means a cacao raw material, that is, cocoa liquor, cocoa butter, cocoa powder (obtained by separating cocoa butter from cocoa liquor, and forming the remainder into a powder), or the like. Also in the case where the frozen dessert has blended therein chocolate base, quasi-chocolate base, or the like, the cacao raw material contained therein is encompassed in the cacao component of the present invention. Incidentally, this “chocolate” is not limited to the chocolate specified in “The Fair Competition Code Concerning Labeling for Chocolates”.

Further, “weight average molecular weight” in the present invention is measured by gel permeation chromatography (GPC) and calculated.

In addition, “frozen dessert mix” in the present invention means a raw material mix before freezing, which is obtained by homogeneously mixing all the frozen dessert raw materials (sometimes excluding frozen dessert raw materials not suitable for heating), and also encompasses a condition after aging. Then, “frozen dessert base mix” means a raw material mix obtained by homogeneously mixing at least some of frozen dessert raw materials other than a water-soluble dietary fiber and a dextrin having a weight average molecular weight of 450 or more.

First, the frozen dessert according to the present invention will be described in detail.

The frozen dessert according to the present invention contains 8 mass % or more of a cocoa butter component, which is a cacao-derived fat component, or 15 mass % or more of cocoa liquor, and has a moisture content of 50 mass % or more. Then, together with the cocoa butter component or cocoa liquor, it also contains 0.1 to 4.5 mass % of a water-soluble dietary fiber and/or a dextrin having a weight average molecular weight of 450 or more.

Here, as described above, by using cocoa liquor, cocoa butter, chocolate base containing the same, or the like as a frozen dessert raw material, the cocoa butter component is adjusted to be 7.5 mass % or more, preferably 8 mass % or more, more preferably 10 mass % or more, and still more preferably 11 mass % or more in the obtained frozen dessert. The upper limit is preferably 20 mass % or less, more preferably 17 mass % or less, and still more preferably 16.5 mass % or less. In addition, cocoa liquor (containing about 52 to 58 mass % of a cocoa butter component) is blended to be 15 mass % or more, preferably 18 mass % or more, and more preferably 20 mass % or more in the obtained frozen dessert. The upper limit is preferably 35 mass % or less, and more preferably 30 mass % or less. In the case where the cocoa butter component is more than 20 mass % in the obtained frozen dessert, or the cocoa liquor blend percentage is more than 35 mass %, the fluidity (viscosity) increases at the time of mixing for the preparation of a frozen dessert mix, resulting in the tendency that the raw materials cannot be uniformly dispersed, or the viscosity during aging becomes extremely high. This is likely to cause problems with production aptitude, such as the deterioration of fluidity necessary for liquid delivery to a freezer.

Incidentally, in such a frozen dessert according to the present invention containing 8 mass % or more of a cocoa butter component or 15 mass % or more of cocoa liquor, for the reason that the flavor of the obtained frozen dessert (particularly the flavor of chocolate) can be further improved, it is preferable that the cacao component is adjusted to be 15 mass % or more, preferably 18 mass % or more, and more preferably 20 mass % or more. Then, as long as the obtained frozen dessert has a cocoa butter component content of 8 mass % or more or a cocoa liquor content of 15 mass % or more, cocoa powder may be used as a part of the cacao component.

Then, in the frozen dessert according to the present invention, together with the cocoa butter component or the cocoa liquor, in order to suppress an increase in the frozen dessert mix viscosity or the frozen dessert hardness, a water-soluble dietary fiber and/or a dextrin having a weight average molecular weight of 450 or more is blended. In the present invention, it is preferable to blend a water-soluble dietary fiber such as indigestible glucan, polydextrose, or indigestible dextrin. A more preferred example of the water-soluble dietary fiber is a water-soluble dietary fiber having a weight average molecular weight of 1,500 to 2,000 and a DE value of about 10 to 40. In particular, for the reason that the obtained frozen dessert has a better balance of flavor, frozen dessert hardness, and frozen dessert mix viscosity, it is extremely preferable to use indigestible glucan as the water-soluble dietary fiber. Such indigestible glucan can be obtained by, for example, the production method described in Hamaguchi et al., J. Appl. Glycosci., 62, 7-13, 2015.

Incidentally, the water-soluble dietary fiber content in the frozen dessert or the frozen dessert mix according to the present invention is measured by the high-performance liquid chromatography (enzyme-HPLC method) described in “Food Labeling (Mar. 30, 2015, Food Labeling Division, Consumer Affairs Agency, No. 139), Annex, Nutrition Labeling”.

In addition, as described above, the weight average molecular weight of the dextrin to be blended in the frozen dessert according to the present invention needs to be 450 or more. The weight average molecular weight is preferably 1,000 or more, and more preferably 1,500 or more. Then, although its DE value is not limited, for the reason that the flavor of the obtained frozen dessert is less affected, the value is particularly preferably about 10 to 40 (e.g., maltodextrin, etc.).

Incidentally, the dextrin content in the frozen dessert or the frozen dessert mix according to the present invention is measured by the HPLC method.

Then, the frozen dessert contains such a water-soluble dietary fiber and/or a dextrin having a weight average molecular weight of 450 or more in an amount of 0.1 to 4.5 mass %, preferably 0.1 to 4 mass %, more preferably 0.12 to 2 mass %, and still more preferably 0.2 to 1.5 mass %, whereby an increase in the frozen dessert hardness or an increase in the frozen dessert mix viscosity due to the influence of the cacao-derived fat component can be suppressed. Incidentally, when the blend percentage of the water-soluble dietary fiber and/or dextrin having a weight average molecular weight of 450 or more is less than 0.1 mass % or more than 4.5 mass %, such effects cannot be obtained.

Further, the moisture content of the frozen dessert according to the present invention is 50 mass % or more, preferably 53 mass % or more, and more preferably 56 mass % or more. When the moisture content is like this, a cacao raw material-containing frozen dessert having a predetermined or higher proportion of a cocoa butter component or cocoa liquor, and yet having a low viscosity in the form of a frozen dessert mix and allowing for smooth soft scoop property in the form a frozen dessert, can be obtained.

Incidentally, the moisture content of the frozen dessert according to the present invention is measured by the following method.

(a) A weighing dish made of aluminum containing 15 to 30 g of quartz sand and a small glass rod is dried for 3 hours in a hot-air circulation dryer set at 100° C. and then allowed to cool in a desiccator for about 1 hour.

(b) The weighing dish is weighed on a precision balance, and then 1.5 to 3.0 g of the sample is precisely weighed.

(c) On a hot plate, the sample is softly stirred using the small glass rod with heating.

(d) After the quartz sand is dried, the weighing dish is dried for 3 hours in a hot-air circulation dryer set at 100° C. and then allowed to cool in a desiccator for about 1 hour.

(e) The weighing dish is weighed on a precision balance, and the moisture [mass %] is determined from the following formula.

Moisture [mass %]=(sample mass−mass after drying)+sample mass×100

Here, in the frozen dessert according to the present invention, as frozen dessert raw materials other than the cacao raw materials (cocoa liquor, cocoa butter, cocoa powder, chocolate base using the same, etc.) and water-soluble dietary fiber and/or dextrin having a weight average molecular weight of 450 or more described above, known frozen dessert raw materials, such as milk raw materials, egg yolk raw materials, oil/fat raw materials, sweeteners, emulsifiers, thickeners, stabilizers, flavoring agents, and alcohols, can be arbitrarily selected and used according to the purpose without particular limitations.

Therefore, the frozen dessert according to the present invention is a product obtained by freezing a food that uses the frozen dessert raw materials described above, and may be, for example, an ice cream, an ice milk, a lact ice, or an ice dessert defined in “The Fair Competition Code Concerning Labeling for Ice Creams and Ice Dessert”, or may also be a frozen dessert (ice dessert) containing no milk raw material (i.e., milk solids). Alternatively, it may also be a frozen dessert not encompassed therein, such as an unbaked cake distributed in a frozen state.

In addition, saccharides that can be used as frozen dessert raw materials are sugar, starch syrup, molasses, glucose/fructose liquid sugar, fructose/glucose liquid sugar, high fructose corn syrup, sugar-added high fructose corn syrup, and the like. In the case of using a liquid sugar, it is preferable to use glucose/fructose liquid sugar or fructose/glucose liquid sugar. In addition, a mixed sugar solution of starch syrup and a liquid sugar may also be used, and it is also possible to separately add starch syrup and a liquid sugar. Then, in the case where the mixed sugar solution is used, their mixing ratio hardly affects the frozen dessert mix viscosity, and it is possible that starch syrup:liquid sugar=1:99 to 99:1, for example. Further, the ratio may be 1:9, 1:8, 1:7, 1:6, 1:5, 1:4, 1:3, 1:2, 1:1, 2:1, 3:1, 4:1, 5:1, 6:1, 7:1, 8:1, 9:1, or the like. It is particularly preferable that starch syrup:liquid sugar=1:1 to 20, more preferably 1:2 to 10.

Incidentally, the frozen dessert according to the present invention is a frozen dessert obtained by freezing and hardening a frozen dessert mix containing a cocoa butter component, cocoa liquor, and the like, and such a frozen dessert contains 10 mass % or more of a cocoa butter component and 15 mass % or more of cocoa liquor, and also contains 0.1 to 4.5 mass % of a water-soluble dietary fiber and/or a dextrin having a weight average molecular weight of 450 or more. That is, the cocoa butter component, cocoa liquor, and cacao component in the frozen dessert according to the present invention are contained in layers of the frozen dessert homogeneously mixed with other frozen dessert raw materials. Therefore, a cocoa butter component, cocoa liquor, and a cacao component contained in materials that are not homogeneously mixed with the frozen dessert mix, such as a material for frozen dessert coating, a material for frozen dessert lamination, and a frozen dessert topping, are not included in the cocoa butter component, cocoa liquor, and cacao component contents in the frozen dessert according to the present invention. The same also applies to the water-soluble dietary fiber, the dextrin having a weight average molecular weight of 450 or more, and moisture.

However, the frozen dessert according to the present invention does not exclude an embodiment enclosing a chocolate, a chocolate sauce, a chocolate jelly, chocolate chips, a chocolate jam, a baked confectionery containing a cacao component, or the like, an embodiment coated with a material for frozen dessert coating containing a cocoa butter component or the like, an embodiment in which a material for frozen dessert lamination containing a cocoa butter component or the like is contained in the laminate, and the like. Of course, an embodiment containing a frozen dessert topping, a material for frozen dessert lamination, or the like containing no cacao components, such as fruits, an embodiment coated with a material for frozen dessert coating containing no cacao components, and the like are not excluded either.

In addition, it is preferable that the frozen dessert according to the present invention is a frozen dessert having an overrun (the volume proportion of air incorporated at the time of freezing a frozen dessert mix relative to the frozen dessert mix volume) of 30 to 50%, and it is more preferable that the overrun is 35 to 45%. This is because the resulting frozen dessert has a rich flavor with a stronger chocolate sensation and also allows for smooth soft scoop property, and a frozen dessert mix having a further reduced viscosity can be obtained.

Then, the frozen dessert according to the present invention thus configured contains 8 mass % or more of a cocoa butter component or 15 mass % or more of cocoa liquor, and yet has a low viscosity in the form of a frozen dessert mix and also has a hardness that allows for smooth soft scoop property in the form of a frozen dessert. As examples of preferred values thereof, the frozen dessert mix viscosity at 5° C. after 16 hours of aging is less than 2,000 mPa·s, more preferably less than 1,960 mPa·s, and particularly preferably less than 1,900 mPa·s, and the frozen dessert hardness at −18° C. is 9 kgf or less, more preferably 8.5 kgf or less, still more preferably 8 kgf or less, and particularly preferably 7.5 kgf or less.

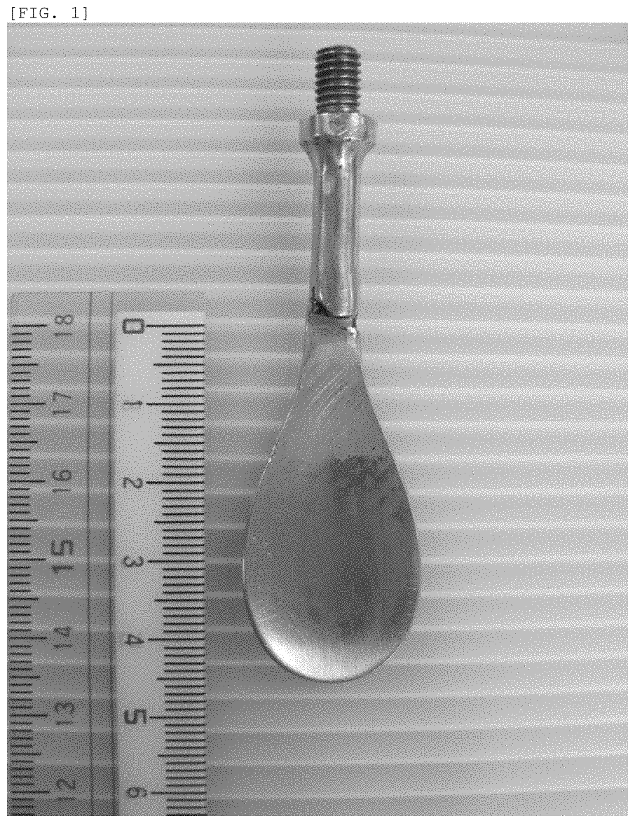

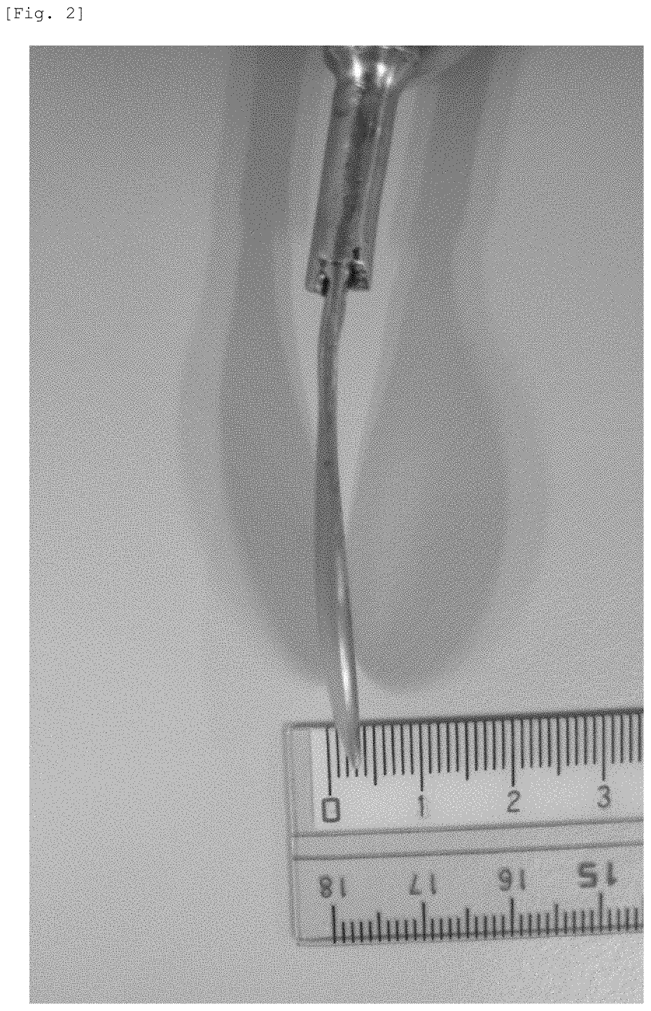

Here, “frozen dessert hardness” in the present invention is determined as follows. With respect to a −18° C. frozen dessert, using a rheometer (Ez-test-100N, Shimadzu Corporation), the plunger shown in FIG. 1 and FIG. 2 (made of stainless steel, medicine spoon type: the medicine spoon-shaped distal end of the plunger, width: 2.2 cm, length: 4.5 cm, thickness: 0.95 mm, depth: 3.37 mm, curvature radius: 10.8 mm) is stuck into the frozen dessert from the direction perpendicular to the frozen dessert surface under the condition at a speed of 100 mm/min, and the maximum load (kgf) at that time is measured as “frozen dessert hardness”.

In addition, “frozen dessert mix viscosity” is determined as follows. With respect to a 5° C. frozen dessert mix after 16 hours of aging, that is, at the time when 16 hours have elapsed after the start of aging by maintaining the frozen dessert mix at 1 to 5° C., the viscosity (mPa·s) is measured using a viscometer (Toki Sangyo Co., Ltd., TVB10M, rotor No.: M3, rotor speed: 60 rpm, rotor revolution time: 30 seconds) as “frozen dessert mix viscosity”. Incidentally, in the present invention, it is preferable that the frozen dessert mix viscosity at 5° C. not only after 16 hours of aging but also after 24 hours of aging is less than 2,000 mPa·s, further less than 1,900 mPa·s.

Next, an example of a method for producing the frozen dessert according to the present invention will be described. However, methods for producing the frozen dessert according to the present invention are not limited to the following example.

As a method for producing the frozen dessert according to the present invention, for example, a method including a step in which a frozen dessert base mix containing a cocoa butter component is made 55° C. or less, and a water-soluble dietary fiber and/or a dextrin having a weight average molecular weight of 450 or more is added to this frozen dessert base mix to a content of 0.1 to 4.5 mass %, thereby giving a frozen dessert mix containing 8 mass % or more of a cocoa butter component or 15 mass % or more of cocoa liquor and having a moisture content of 50 mass % or more, can be mentioned.

In this method, first, frozen dessert raw materials other than the water-soluble dietary fiber and the dextrin having a weight average molecular weight of 450 or more described above (including a cacao raw material containing 8 mass % or more of a cocoa butter component or 15 mass % or more of cocoa liquor in the obtained frozen dessert mix obtained, and water) are mixed in a tank or the like to prepare a frozen dessert base mix containing a cocoa butter component. Incidentally, in the case where trace amounts of frozen dessert raw materials not suitable for heating, such as a flavoring agent, are used, such raw materials may be excluded. In addition, it is also possible that some frozen dessert raw materials are added together with the water-soluble dietary fiber or dextrin having a weight average molecular weight of 450 or more described below. The mixing temperature is not limited. However, in terms of ease of dispersion and dissolution of frozen dessert raw materials in water, the condition is preferably about 30 to 80° C., and more preferably about 40 to 70° C.

Then, to the obtained frozen dessert base mix, a water-soluble dietary fiber and/or a dextrin having a weight average molecular weight of 450 or more is added such that the content in the obtained frozen dessert mix will be 0.1 to 4.5 mass %, mixed, and dissolved, thereby giving a frozen dessert mix having a moisture content of 50 mass % or more. In this case, after cooling the frozen dessert base mix to 55° C. or less, the water-soluble dietary fiber and/or dextrin having a weight average molecular weight of 450 or more is added. After the addition, mixing, and dissolution, the frozen dessert mix may be warmed to about 75° C.

Incidentally, in order to prevent the entry of various germs or the like, it is preferable that these mixing steps are performed in a plurality of devices connected through pipes.

The frozen dessert mix thus obtained, which has a moisture content of 50 mass % or more, and contains 8 mass % or more of a cocoa butter component or 15 mass % or more of cocoa liquor and 0.1 to 4.5 mass % of a water-soluble dietary fiber and/or a dextrin having a weight average molecular weight of 450 or more, is subjected to a filtration treatment using a filter or the like (impurity removal treatment) or a homogenization treatment, as necessary.

Subsequently, the frozen dessert mix is maintained at 65 to 75° C. for 10 to 30 minutes and thus sterilized. Then, after sterilization, the frozen dessert mix is cooled to 1 to 10° C., and frozen dessert raw materials not suitable for heating (flavoring agent, etc.) are added as necessary, followed by aging for about 3 to 72 hours, wherein the frozen dessert mix solution is maintained at a temperature of 1 to 10° C., preferably 1 to 5° C., with a certain degree of fluidity without being frozen. As a result of this aging, the fat in the frozen dessert mix is crystallized, and also the physical properties of the frozen dessert mix are stabilized. Incidentally, the frozen dessert mix viscosity described above is the viscosity of the 5° C. frozen dessert mix after being subjected to such aging for 16 hours measured by the above method. Then, this aging is followed by freezing. In freezing, for example, the frozen dessert mix is stirred at a temperature of −2° C. to −10° C. over a predetermined period of time. The overrun at this time is set at about 30 to 50%. As a result of this freezing, the frozen dessert mix is cooled, and ice crystals are generated. Then, the frozen dessert after freezing is packed in a container or the like, and the frozen dessert is cooled to −13° C. or less and hardened (rapid freezing). Incidentally, it is preferable that the storage of the obtained frozen dessert product is performed at a temperature of −25° C. or less.

The frozen dessert according to the present invention can be produced in this manner, but the present invention is not limited to the above embodiment. In addition, as long as the effects of the present invention are not significantly affected, it is also possible to suitably add further steps, such as a topping step using a frozen dessert topping, a coating step using a material for frozen dessert coating, and a laminating step using a material for frozen dessert lamination.

Hereinafter, examples of the present invention will be described. However, the present invention is not limited to the following examples, and various modifications can be made within the technical spirit of the present invention.

### Examples

Using the frozen dessert raw materials (mass %) described in Table 1 below, frozen dessert mixes of Examples 1 to 12 and Comparative Examples 1 to 3 were prepared.

Specifically, predetermined amounts of cocoa liquor (cocoa butter component content: 55 mass %), sugar, a mixed sugar solution of starch syrup and glucose/fructose liquid sugar, an emulsifier, and water were mixed and dissolved under stirring at 60 to 70° C. to prepare a frozen dessert base mix. Then, the frozen dessert base mix was made 55° C. or less, and a predetermined amount of one of indigestible glucan (weight average molecular weight: 1,900, DE value: 10), maltodextrin (weight average molecular weight: 1,700, DE value: 10), dextrin (weight average molecular weight: 450, DE value: 40), polydextrose (weight average molecular weight: 1,500), and indigestible dextrin (weight average molecular weight: about 2,000, DE value: about 12) was added and dissolved under stirring, then warmed to 65 to 70° C., and maintained for 10 minutes, thereby giving a frozen dessert mix (Examples 1 to 12, Comparative Example 3). Incidentally, in Comparative Example 1 and Comparative Example 2, a frozen dessert base mix obtained by mixing and dissolving predetermined amounts of the frozen dessert raw materials described above was directly placed at 65 to 70° C. and maintained for 10 minutes, thereby giving a frozen dessert mix.

TABLE 1

| | Exam- | Exam- | Exam- | Exam- | Exam- | Exam- | Exam- | Exam- |
|---|---|---|---|---|---|---|---|---|
| | ple 1 | ple 2 | ple 3 | ple 4 | ple 5 | ple 6 | ple 7 | ple 8 |
| Cocoa liquor | 20 | 20 | 20 | 20 | 20 | 20 | 20 | 20 |
| Sugar | 11.51 | 11.42 | 11.33 | 11.24 | 10.88 | 9.43 | 8.7 | 11.12 |
| Mixed sugar | 12 | 12 | 12 | 12 | 12 | 12 | 12 | 12 |
| solution | | | | | | | | |
| (starch syrup- | | | | | | | | |
| liquid sugar) | | | | | | | | |
| Emulsifier | 1.2 | 1.2 | 1.2 | 1.2 | 1.2 | 1.2 | 1.2 | 1.2 |
| Indigestible | 0.125 | 0.25 | 0.375 | 0.5 | 1 | 3 | 4 | |
| glucan | | | | | | | | |
| Maltodextrin | | | | | | | | 0.5 |
| Dextrin | | | | | | | | |
| Polydextrose | | | | | | | | |
| Indigestible | | | | | | | | |
| destrin | | | | | | | | |
| Subtotal | 44.835 | 44.87 | 44.905 | 44.94 | 45.08 | 45.63 | 45.9 | 44.82 |
| Water | 55.165 | 55.13 | 55.095 | 55.06 | 54.92 | 54.37 | 54.1 | 55.18 |
| Total | 100 | 100 | 100 | 100 | 100 | 100 | 100 | 100 |
| Cocoa butter | 11 | 11 | 11 | 11 | 11 | 11 | 11 | 11 |
| component | | | | | | | | |
| Moisture | 58.6 | 58.6 | 58.6 | 58.6 | 58.6 | 58.6 | 58.6 | 58.6 |

| | | | | | Compar- | Compar- | Compar- |
|---|---|---|---|---|---|---|---|
| | | | | | ative | ative | ative |
| | Exam- | Exam- | Exam- | Exam- | Exam- | Exam- | Exam- |
| | ple 9 | ple 10 | ple 11 | ple 12 | ple 1 | ple 2 | ple 3 |
| Cocoa liquor | 20 | 20 | 20 | 20 | 20 | 10 | 10 |
| Sugar | 11.12 | 11.1 | 11.12 | 8.7 | 11.6 | 11.24 | 11.24 |
| Mixed sugar | 12 | 12 | 12 | 12 | 12 | 25.3 | 25.3 |
| solution | | | | | | | |
| (starch syrup- | | | | | | | |
| liquid sugar) | | | | | | | |
| Emulsifier | 1.2 | 1.2 | 1.2 | 1.2 | 1.2 | 1.2 | 1.2 |
| Indigestible | | | | | | | 0.5 |
| glucan | | | | | | | |
| Maltodextrin | | | | | | | |
| Dextrin | 0.5 | | | | | | |
| Polydextrose | | 0.5 | | | | | |
| Indigestible | | | 0.5 | 3 | | | |
| destrin | | | | | | | |
| Subtotal | 44.82 | 44.8 | 44.82 | 44.9 | 44.8 | 47.74 | 48.24 |
| Water | 55.18 | 55.8 | 55.18 | 55.1 | 55.2 | 52.26 | 51.76 |
| Total | 100 | 100 | 100 | 100 | 100 | 100 | 100 |
| Cocoa butter | 11 | 11 | 11 | 11 | 11 | 5.5 | 5.5 |
| component | | | | | | | |
| Moisture | 58.6 | 58.6 | 58.6 | 58.6 | 58.6 | 58.6 | 58.6 |

Then, the frozen dessert mixes of Examples 1 to 12 and Comparative Examples 1 to 3 were cooled in a refrigerator at 4° C., then aged for 16 to 24 hours, and subsequently frozen in a batch freezer at −2 to −10° C. with an overrun of 40%. After freezing, they were each packed in a 100-ml cup container and then hardened in a shock freezer at −40° C., thereby preparing frozen desserts (ice desserts) of Examples 1 to 12 and Comparative Examples 1 to 3. Incidentally, the cocoa butter component (calculated from the content of the cocoa butter component contained in cocoa liquor) and moisture contents (mass %) of frozen desserts are also shown in Table 1 above.

The frozen desserts of Examples 1 to 12 and Comparative Examples 1 to 3 thus obtained were subjected to hardness evaluation, and the frozen dessert mixes of Examples 1 to 12 and Comparative Examples 1 to 3 were subjected to after-aging viscosity evaluation.

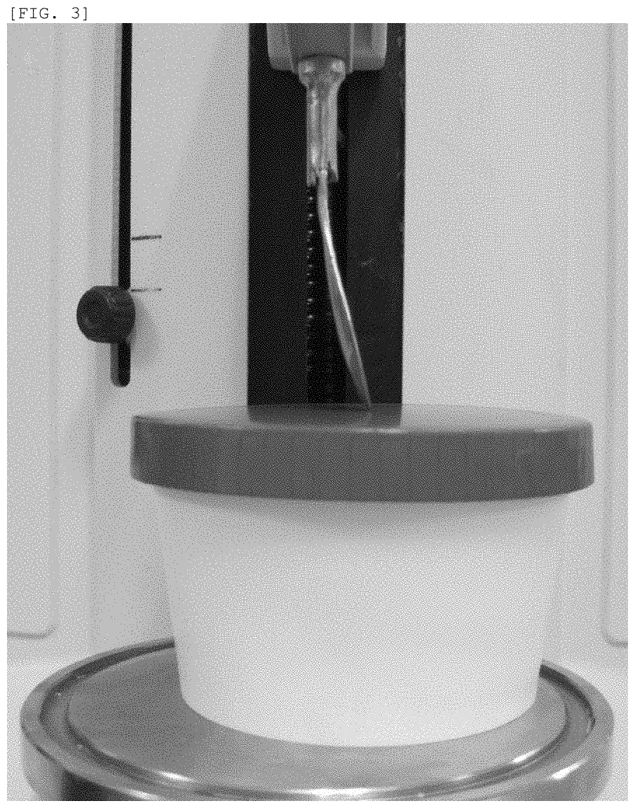

Specifically, first, the frozen dessert hardness (kgf) was measured as follows. Using a rheometer (Ez-test-100N, Shimadzu Corporation), the plunger shown in FIG. 1 and FIG. 2 (made of stainless steel, medicine spoon type: the medicine spoon-shaped distal end of the plunger, width: 2.2 cm, length: 4.5 cm, thickness: 0.95 mm, depth: 3.37 mm, curvature radius of the plunger distal end: 10.8 mm) was stuck in the direction perpendicular to the surface of a −18° C. frozen dessert sample (temperature-controlled for one day in a −18° C. thermostat) under the condition at a speed of 100 ram/min as shown in FIG. 3, and the maximum load was analyzed using an analysis PC software (TRAPEZIUM X) (FIG. 3 shows hardness measurement assuming the lid of a frozen dessert container as a frozen dessert sample surface).

In addition, with respect to the frozen dessert mix viscosity (mPa·s), using a viscometer (Toki Sangyo Co., Ltd., TVB10M, rotor No.: M3, rotor speed: 60 rpm, rotor revolution time: 30 seconds), the viscosity of a 5° C. frozen dessert mix after 16 to 24 hours from the start of aging was measured.

Further, the frozen desserts of the examples and comparative examples were also subjected to flavor evaluation.

Specifically, a plurality of special panelists sufficiently trained for flavor evaluation and having distinguishability ate frozen desserts, and evaluated the “flavor (taste or aroma of chocolate, richness, etc.)” at that time. The flavor evaluation was performed using the evaluation criteria shown below with Comparative Example 1 (a frozen dessert not containing a water-soluble dietary fiber or a predetermined dextrin) serving as a reference sample so that panelists had common evaluation criteria.

### <Evaluation Criteria for “Flavor” of Frozen Dessert>

A: Equal to Comparative Example 1.

B: Slightly different from Comparative Example 1 in the taste retention time or richness, but within a suitable range as a frozen dessert product.

C: The top sour taste and aroma are slightly weaker than in Comparative Example 1, but within an acceptable range as a frozen dessert product.

D: The chocolate flavor is remarkably weaker than in Comparative Example 1, and the richness is insufficient.

The evaluation results of frozen dessert hardness, frozen dessert mix viscosity, and frozen dessert flavor are shown in Table 2 below.

In addition, from these results, overall evaluation of each frozen dessert was also performed. Specifically, a rating of “most preferable (1)” was given to those having a frozen dessert hardness of 7.5 kgf or less, a frozen dessert mix viscosity of less than 1,900 mPa·s, and a flavor evaluation of B or higher, a rating of “preferable (2)” was given to those having a frozen dessert hardness of more than 7.5 kgf and 8 kgf or less, a frozen dessert mix viscosity of less than 1,900 mPa·s, and a flavor evaluation of B or higher, a rating of “slightly preferable (3)” was given to those having a frozen dessert hardness of more than 8 kgf and 9 kgf or less, a frozen dessert mix viscosity of 1,900 mPa·s or more and less than 2,000 mPa·s, and a flavor evaluation of B or higher, a rating of “acceptable as a product (4)” was given to those having a frozen dessert hardness of more than 8 kgf and 9 kgf or less, a frozen dessert mix viscosity of 1,900 mPa·s or more and less than 2,000 mPa·s, and a flavor evaluation of C, and a rating of “disqualified as a product (5)” was given to those having a frozen dessert hardness of more than 9 kgf, a frozen dessert mix viscosity of 2,000 mPa·s or more, or a flavor evaluation of D. The results of the overall evaluation of each frozen dessert are also shown in Table 2 below.

TABLE 2

| | Exam- | Exam- | Exam- | Exam- | Exam- | Exam- | Exam- | Exam- |
|---|---|---|---|---|---|---|---|---|
| | ple 1 | ple 2 | ple 3 | ple 4 | ple 5 | ple 6 | ple 7 | ple 8 |
| Hardness (kgf) | 7.8 | 7.1 | 7.0 | 7.2 | 8.0 | 8.5 | 9.0 | 7.8 |
| Viscosity (mPa · s) | 1863 | 1833 | 1779 | 1862 | 1838 | 1995 | 1954 | 1824 |
| Flavor evaluation | B | B | B | B | B | B | B | B |
| Overall evaluation | 2 | 1 | 1 | 1 | 2 | 3 | 3 | 2 |

| | | | | | Compar- | Compar- | Compar- |
|---|---|---|---|---|---|---|---|
| | | | | | ative | ative | ative |
| | Exam- | Exam- | Exam- | Exam- | Exam- | Exam- | Exam- |
| | ple 9 | ple 10 | ple 11 | ple 12 | ple 1 | ple 2 | ple 3 |
| Hardness (kgf) | 7.8 | 8.2 | 8.1 | 7.6 | 9.4 | 1.1 | 1.2 |
| Viscosity (mPa · s) | 1880 | 1811 | 1935 | 1955 | 1822 | 823 | 780 |
| Flavor evaluation | B | C | A | A | | D | D |
| Overall evaluation | 2 | 4 | 3 | 3 | 5 | 5 | 5 |

First, from the results of Examples 1 to 7 and Comparative Example 1, it was confirmed that in a frozen dessert containing 20 mass % of cocoa liquor (11 mass % of cocoa butter component), when 0.125 to 4 mass % of indigestible glucan is blended, the frozen dessert hardness at −18° C. can be made 9 kgf or less, and also the frozen dessert mix viscosity at 5° C. after 16 to 24 hours of aging can be made less than 2,000 mPa·s. Then, it was also revealed that in the case where 0.125 to 1 mass % of indigestible glucan is blended, the frozen dessert hardness at −18° C. can be made 8 kgf or less, and the frozen dessert mix viscosity at 5° C. after 16 to 24 hours of aging can be made less than 1870 mPa·s, which is more preferable, and also that in the case where 0.25 to 0.5 mass % of indigestible glucan is blended, the frozen dessert hardness at −18° C. can be made 7.5 kgf or less, which is particularly preferable. Further, from these frozen dessert flavor evaluation results, it was also confirmed that the blending of such indigestible glucan does not significantly affect the flavor of frozen dessert products.

Then, from the results of Comparative Example 2 and also of Comparative Example 3 where 0.5 mass % of indigestible glucan was blended therein, it was also confirmed that in a frozen dessert containing 10 mass % of cocoa liquor (5.5 mass % of cocoa butter component), because the cocoa butter component content is low, the frozen dessert hardness or the frozen dessert mix viscosity is not so high, and thus the blending of indigestible glucan has almost no effect or influence on the frozen dessert hardness or frozen dessert mix viscosity. Further, in both Comparative Example 2 and Comparative Example 3, the flavor of chocolate was weak, and richness was also insufficient. Thus, as compared with Comparative Example 1 containing 20 mass % cocoa liquor, the flavor evaluation was remarkably poor.

In addition, from the results of Examples 8 to 12, it was confirmed that in a frozen dessert containing 20 mass % cocoa liquor (11 mass % cocoa butter component), when 0.5 to 3 mass % of maltodextrin or dextrin having a weight average molecular weight of 450 or more, polydextrose, or indigestible dextrin is blended, the frozen dessert hardness at −18° C. can be made 8.5 kgf or less, and also the frozen dessert mix viscosity at 5° C. after 16 to 24 hours of aging can be made less than 1,960 mPa·s. Then, from these frozen dessert flavor evaluation results, it was confirmed that the blending of such maltodextrin, dextrin, polydextrose, or indigestible dextrin does not significantly affect the flavor of frozen dessert products either.

Incidentally, as references, frozen desserts having blended therein 3 mass % of the above maltodextrin or dextrin instead of the indigestible dextrin in the frozen dessert of Example 12 were also prepared, and subjected to the evaluation of frozen dessert hardness and frozen dessert flavor and also to the evaluation of frozen dessert mix viscosity described above in the same manner. As a result, the frozen dessert hardness at −18° C. of the frozen dessert having blended therein 3 mass % of maltodextrin was 7.8 kgf, while the frozen dessert hardness at −18° C. of the frozen dessert having blended therein 3 mass % of dextrin was 8.8 kgf, and the evaluation of flavor was B in each case. Then, the frozen dessert mix viscosity at 5° C. after 16 to 24 hours of aging was 2,000 mPa·s or more in each case.

From the above results, it was revealed that in a frozen dessert containing 11 mass % of a cocoa butter component and having a moisture content of 58.6 mass %, when 0.125 to 4 mass % of indigestible glucan, polydextrose, or indigestible dextrin, which is a water-soluble dietary fiber, or maltodextrin or dextrin having a weight average molecular weight of 450 or more is contained, a frozen dessert product having a low frozen dessert mix viscosity at 5° C. after 16 to 24 hours of aging, a low frozen dessert hardness, and a favorable flavor is obtained.

This application claims the priority based on Japanese Patent Application No. 2019-033582 filed on Feb. 27, 2019, the disclosures of which are all incorporated herein.

What is claimed is:

1. A frozen dessert having a moisture content of 50 mass % or more, comprising: 8 mass % or more of a cocoa butter component; and 0.1 to 4.5 mass % of a water-soluble dietary fiber and/or a dextrin having a weight average molecular weight of 450 or more.

2. A frozen dessert having a moisture content of 50 mass % or more, comprising: 15 mass % or more of cocoa liquor; and 0.1 to 4.5 mass % of a water-soluble dietary fiber and/or a dextrin having a weight average molecular weight of 450 or more.

3. The frozen dessert according to claim 1, which comprises 15 mass % or more of a cacao component.

4. The frozen dessert according to claim 1, wherein frozen dessert mix viscosity at 5° C. after 16 hours of aging is less than 2,000 mPa·s, and frozen dessert hardness at −18° C. is 9 kgf or less.

5. The frozen dessert according to claim 2, which comprises 15 mass % or more of a cacao component.

6. The frozen dessert according to claim 2, wherein frozen dessert mix viscosity at 5° C. after 16 hours of aging is less than 2,000 mPa·s, and frozen dessert hardness at −18° C. is 9 kgf or less.
